(19) United States
(12) Patent Application Publication
(10) Pub. No.: US 2012/0260517 A1
(43) Pub. Date: Oct. 18, 2012

(54) Apparatus and Method for Reducing Substrate Pattern Collapse During Drying Operations

(75) Inventors: Eric Lenz, Pleasanton, CA (US); Mike Ravkin, Los Altos, CA (US); Katrina Mikhaylichenko, San Jose, CA (US)

(73) Assignee: Lam Research Corporation, Fremont, CA (US)

(21) Appl. No.: 13/089,186

(22) Filed: Apr. 18, 2011

(51) Int. Cl. F26B 3/00

(52) U.S. Cl. 34/357; 34/92

(57) ABSTRACT

Apparatuses and methods for drying a surface of a substrate includes a proximity drying head having a head body that includes a process surface configured to be disposed opposite a surface of a substrate when present. The process surface includes a first region, a second region and a third region. The first region is defined at a leading edge of the head body and includes a cavity region that is recessed into the head body. The cavity region includes a plurality of inlet ports that are used to introduce a vapor fluid to the cavity region. The second region is disposed proximate to the surface of the substrate when present and is located beside the first region. The third region is disposed proximate to the surface of the substrate when present and is located beside the second region. A plurality of vacuum ports is defined at the interface of the second region and the third region. The third region includes a plurality of angled inlet ports that are directed toward the second region. A method for performing a drying operation includes applying heated isopropyl alcohol as vapor to a wafer surface in the first region and heating the underside region of the wafer corresponding to the first region. Heated Nitrogen is injected to the surface of the wafer in the third region. The deionized water and isopropyl alcohol are removed from the surface of the wafer through the vacuum ports along with the Nitrogen so as to leave the wafer surface substantially dry.

### FIELD OF THE INVENTION

The present invention relates generally to semiconductor substrate processing, and more particularly, to apparatus and methods for preventing patterns formed on the substrate of a wafer from collapsing during a drying operation.

### DESCRIPTION OF THE RELATED ART

Features defining Integrated Circuits (ICs) are formed using various fabrication operations. The various fabrication operations include etching, deposition, cleaning/rinsing, drying, etc. Due to the continued advancement in fabrication techniques, features sizes continue to shrink while the performance of the resulting IC devices similarly increase. Although increased performance is always welcomed, this trend continues to require improved fabrication processes to handle increased feature density and high-aspect ratio patterns.

Increased feature density and high-aspect ratio patterns, although result in increased performance, do introduce challenges during substrate cleaning, rinsing and/or drying operations. Specifically, the surface tension of fluids (e.g., chemistries, deionized water (DIW), etc.) used in rinsing and drying operations create pressures that are inversely proportional to the distance between the features (i.e., patterns). It has been observed, that the increase in pressure between features tends to cause a “pulling effect,” that in some cases can cause collapse in features. For example, when deionized water (DIW) is used to rinse a substrate having 20 nanometer features, the pressure exerted in and around the features during a drying process can reach 1,000 pounds per square inch (psi). This pressure also tends to increase in certain areas where adjacent feature patterns get pulled together.

Conventional methods have used a Nitrogen/IPA (isopropyl alcohol) vapor mixture to dry DIW from the wafer surface, when a rinse head alone is used. The mixture does cause a surface tension gradient flow, however, what is left is a mixture of the IPA and the DIW used in an adjacent rinsing operation. As the resulting mixture evaporates higher concentrations of DIW than IPA are left. Thus, when the wafer is subjected to the drying operation, more DIW is left behind on the wafer. The DIW is subsequently removed with evaporative drying operation, that is subject to surrounding conditions. Because a higher concentration of DIW remains for the drying operation, more pressure and pulling is placed on adjacent feature patterns, which can cause damage to the features resulting in possible feature collapses and reduced yields.

In view of the foregoing, there is a need to efficiently remove fluids during rinsing and drying operations conducted by a process head placed in proximity to a substrate surface, while substantially reducing surface tension in and around features patterns, thus reducing the potential for feature collapse.

It is in this context, embodiments of the invention arise.

### SUMMARY

The present invention fills the need by providing improved apparatuses and method for preventing features of patterns that are formed on a surface of a wafer from collapsing during a drying operation. It should be appreciated that the present invention can be implemented in numerous ways, including as apparatuses and a method. Several inventive embodiments of the present invention are described below.

In one embodiment, an apparatus for drying a surface of a substrate is disclosed. The proximity drying head comprises a head body that includes a process surface configured to be disposed opposite a surface of a substrate when present. The process surface includes a first region, a second region and a third region. The first region is defined at a leading edge of the head body and includes a cavity region. The cavity region is recessed into the head body and includes a plurality of inlet ports. The plurality of inlet ports are used to introduce a vapor fluid to the cavity region. The second region is disposed proximate to the surface of the substrate when present. The second region is located beside the first region. The third region is disposed proximate to the surface of the substrate when present and is located beside the second region. A plurality of vacuum ports is defined at the interface of the second region and the third region. The third region includes a plurality of angled inlet ports that are directed toward the second region.

In another embodiment, a method for performing a drying operation using a drying proximity head is disclosed. The method includes applying heated isopropyl alcohol as vapor to the surface of the wafer in a region between a surface of the drying proximity head and a head surface of the wafer when the wafer is present. The wafer has undergone a rinsing operation by a separate rinse proximity head prior to the application of the isopropyl alcohol. The surface of the wafer has a layer of deionized water, IPA, or both from the rinsing operation thereby substantially lowering or preventing forces due to surface tension near any features formed on the surface of the wafer. A region under the wafer where the heated isopropyl alcohol is applied is heated. Heated Nitrogen is injected to the surface of the wafer. The heated Nitrogen aids in substantially evaporating the deionized water and isopropyl alcohol from the surface of the wafer and forcing the IPA vapor toward the separate rinse proximity head (rinse head). The deionized water and isopropyl alcohol are removed from the surface of the wafer along with the Nitrogen so as to leave the wafer surface substantially dry. The operations of applying heated IPA, heating a region, injecting heated Nitrogen and removing the Nitrogen along with deionized water and isopropyl alcohol are performed between the surface of the drying proximity head and the surface of the wafer after the rinse operation is performed by the separate rinse proximity head.

In yet another embodiment of the invention, an apparatus for drying a surface of a wafer is disclosed. The apparatus includes a proximity head disposed over a top surface of the wafer when present. The proximity head includes an opposing process surface disposed opposite a surface of the wafer when present. The opposing process surface includes a plurality of inlet and outlet ports disposed therein. The inlet and outlet ports define distinct treatment regions on the surface of the wafer. The proximity head includes an IPA applicator disposed in a first region. The IPA applicator is configured to apply heated isopropyl alcohol as a vapor meniscus to the wafer surface when present through a first set of inlet ports so as to cover an active condensation region over the surface of the wafer. The proximity head is configured to define a cavity region so as to substantially contain the IPA vapor applied in the active condensation region. A set of outlet ports connected to a vacuum source is disposed in a second region. The set of outlet ports are configured to substantially remove the IPA and any chemistry released from the surface of the wafer. A Nitrogen applicator is disposed in a third region and is configured to apply Nitrogen through a second set of inlet ports. The applied Nitrogen substantially covers a rapid evaporation region defined over the surface of the wafer when present. The second set of inlet ports of the proximity head is configured to direct the applied Nitrogen toward the second region so as to substantially release and displace isopropyl alcohol and any liquid chemical from around the features and on the surface of the wafer. The second region is adjacent to the first region and the third region is adjacent to the second region.

Other aspects and advantages of the invention will become more apparent from the following detailed description, taken in conjunction with the accompanying drawings, illustrating by way of example the present invention.

### BRIEF DESCRIPTION OF THE DRAWINGS

The invention may best be understood by reference to the following description taken in conjunction with the accompanying drawings. These drawings should not be taken to limit the invention to the preferred embodiments, but are for explanation and understanding only.

FIG. 1 is a simplified schematic diagram illustrating a high throughput area with active features that are prone to collapse due to high surface tension of liquid chemical applied to the surface of the wafer.

FIG. 2A illustrates a simplified schematic diagram of a system using a proximity head with a heat block configured to dry the substrate, in one embodiment of the invention.

FIG. 2B illustrates a variation of the system illustrated in FIG. 2A that is used in drying the substrate, in an alternate embodiment of the invention.

FIG. 2C illustrates a simplified schematic diagram of a system using rinse heads and dry head for rinsing and drying the wafer, in one embodiment of the invention.

FIG. 2D illustrates a overhead view of the wafer as it travels under the chemical head, rinse head and dry head during rinsing and drying operation, in one embodiment of the invention.

FIG. 3 is a detailed schematic diagram of an apparatus using a proximity head to dry the wafer after a rinsing operation, in one embodiment of the invention.

FIGS. 4A and 4B illustrate a schematic diagram of a proximity head system used for rinsing and drying the wafer, in different embodiments of the invention.

FIG. 4C illustrates an ambient controlled chamber within which is disposed the rinse head and dry head are used in rinsing and drying the wafer, in one embodiment of the invention.

FIG. 5 illustrates a prototype of a portion of a dry head used in the drying operation, in one embodiment of the invention.

FIG. 6 illustrates a flowchart of operations used in drying the wafer surface without damaging the patterns, in one embodiment of the invention.

### DETAILED DESCRIPTION

Several embodiments for preventing patterns from collapsing during a drying operation, will now be described. It will be obvious, however, to one skilled in the art, that the present invention may be practiced without some or all of these specific details. In other instances, well known process operations have not been described in detail in order not to unnecessarily obscure the teachings of the present invention.

A wafer, after undergoing a rinsing operation to remove some of the chemicals used to fabricate or clean patterns, is treated to a drying operation so as to remove the rinsing fluids and/or chemicals that remain in/around the patterns and on the surface of the wafer. As used herein, patterns are defined by features that remain after an etching has been completed on a surface of a material or the substrate itself (e.g., silicon wafer). Example materials include silicon, dielectrics, polysilicon, metals, and the like. The resulting features can define transistors, connections to transistors and/or interconnect metal lines. The etched regions, in subsequent operations, can be filled with materials (e.g., metallization) to thus define metal features, interconnects, vias, and the like. The process, as is known, is repeated many times during the fabrication phases needed to define the resulting IC chips from the starting semiconductor wafer.

As noted earlier, rinsing fluids will accumulate around pattern features and removal during drying should occur without damaging the features. Also noted earlier is that capillary regions formed between high aspect ratio patterns result in increased surface tension forces during drying. Conventional methods rely on the replacement of one liquid with another liquid of lower surface tension to avoid damaging patterns. However, current application methods and structures find it difficult to completely displace one liquid with another liquid in a narrow capillary region, without damaging high aspect ratio patterns.

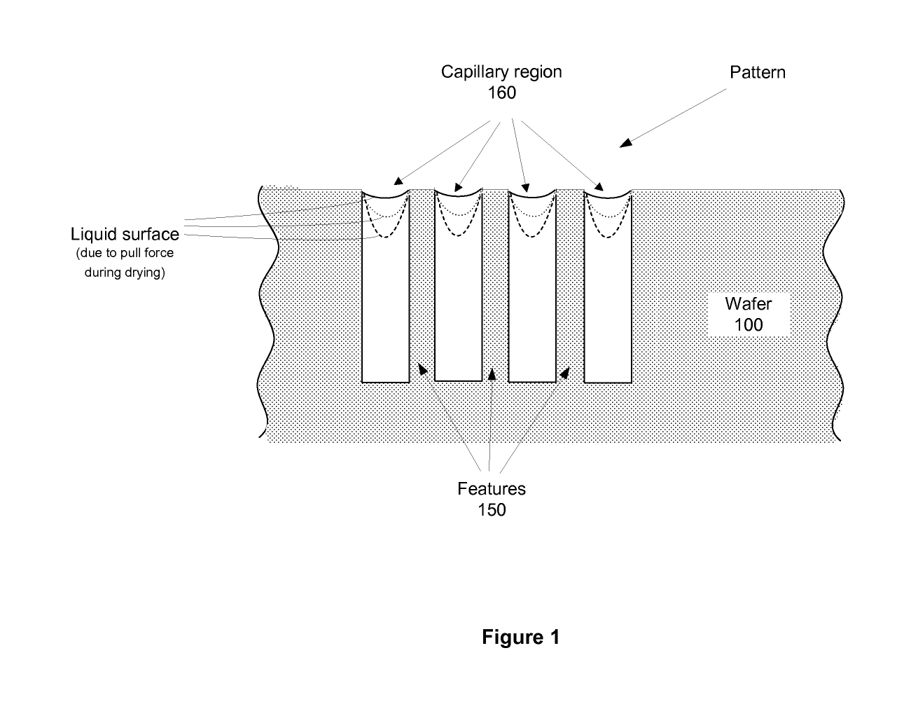

FIG. 1 shows a schematic diagram of a portion of a wafer 100 with defined high-aspect ratio features 150 that define a pattern undergoing a conventional drying operation. When a single proximity head is used to rinse and dry, the DIW used for rinsing tends to mix with the Nitrogen (N2)/isopropyl alcohol (IPA) used during drying. Thus, the concentration of IPA in the resulting mixture is reduced, e.g., about 40% IPA to about 60% DIW. During the drying operation, the IPA will evaporate more quickly and, due to the lowered concentration of the IPA in the mixture, will leave mostly deionized water (DIW) in the remaining fluid mixture to be removed by subsequent evaporation.

The DIW in and around the features 150 and the depth of capillary region 160 formed between the features 150 causes an increase in the surface tension of the liquid. This increase in the surface tension causes the curvature of the liquid surface in the capillary region to become more pronounced, as shown by the dotted lines within the capillary region 160 in FIG. 1, thereby pulling the features 150 toward each other, and which may cause patterns 150 to collapse. As an example, for a wafer with 20-30 nanometer (nm) features, a drying operation may provide about 70 atmospheres of pressure in the capillary region between the features.

In order to prevent such damage, the embodiments defined herein provide structures and method for drying surfaces while reducing the surface tension caused by increased DIW mixtures (i.e., and reduced IPA concentrations) at the time of drying.

In one embodiment, IPA is applied as a vapor after the rinsing operation is completed. In this embodiment, the rinsing operation is performed in one proximity head and the drying operation is performed in another proximity head. In another embodiment, one proximity head is used for rinsing and drying, but a separation is maintained between the rinsing meniscus and the drying region to reduce mixing by providing a region of condensing IPA vapor there-between. In one embodiment, in the drying region, the IPA is heated and the heated IPA in vapor form is applied to the surface of the wafer. Applying IPA as vapor reduces the amount of the IPA needed to provide an uniform and thin coating over the surface of the wafer.

The IPA vapor has a significantly lower surface tension than the DIW applied to the surface of the wafer at the end of the rinsing operation. The lower surface tension of the IPA vapor produces the well-known “Marangoni” effect on the wafer surface at the interface of the IPA vapor and the rinsing fluid (i.e., DIW or chemistry/DIW mixtures), which will induce the surface tension gradient. The Marangoni effect will therefore assist the rinsing fluid (e.g., such as DIW, having high surface tension) to release from the wafer surface, thereby effectively displacing the higher tension rinsing fluid with the lower surface tension IPA. In one embodiment, the IPA vapor applied to the wafer surface is heated so that IPA can be maintained in vapor form. As a benefit, the IPA with its low surface tension properties, substantially reduces the pulling forces on features being subsequently dried with evaporation. In one embodiment, any remaining IPA vapor may be exposed to nitrogen at the trailing edge of the drying head. In one embodiment, the nitrogen may also heated before it is applied to the wafer surface. The heated nitrogen further enhances the evaporation process, leaving behind a substantially dry wafer surface and avoiding the aforementioned damage to features.

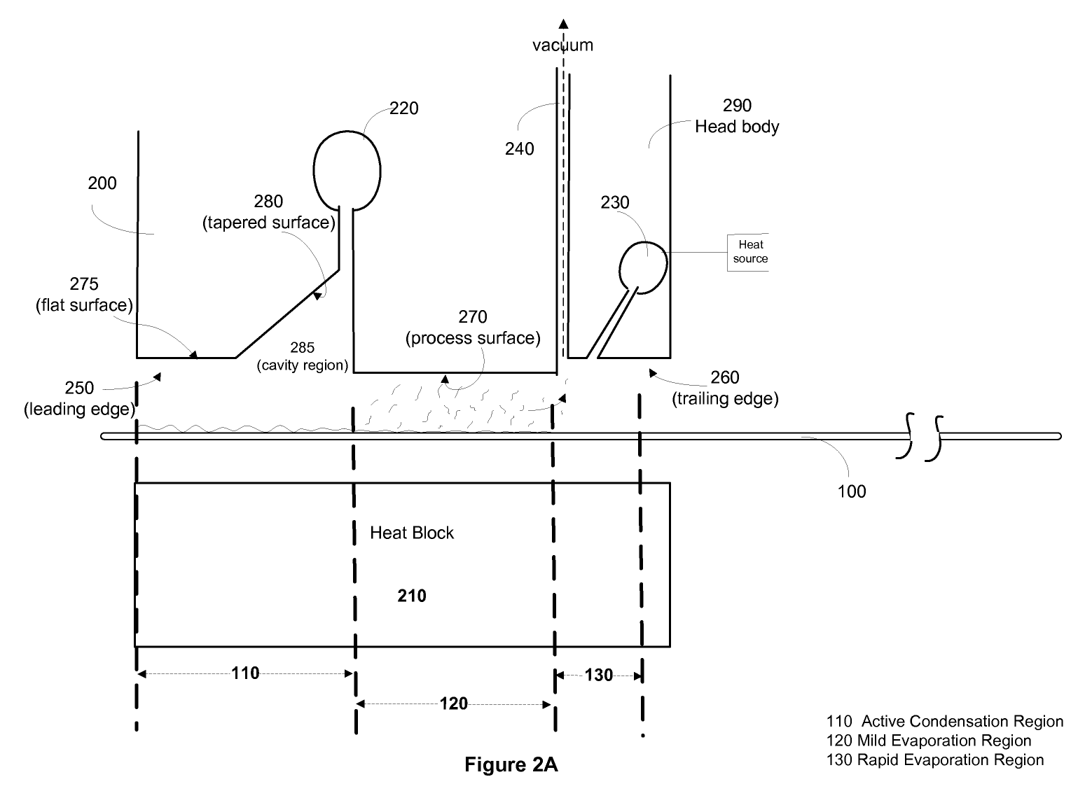

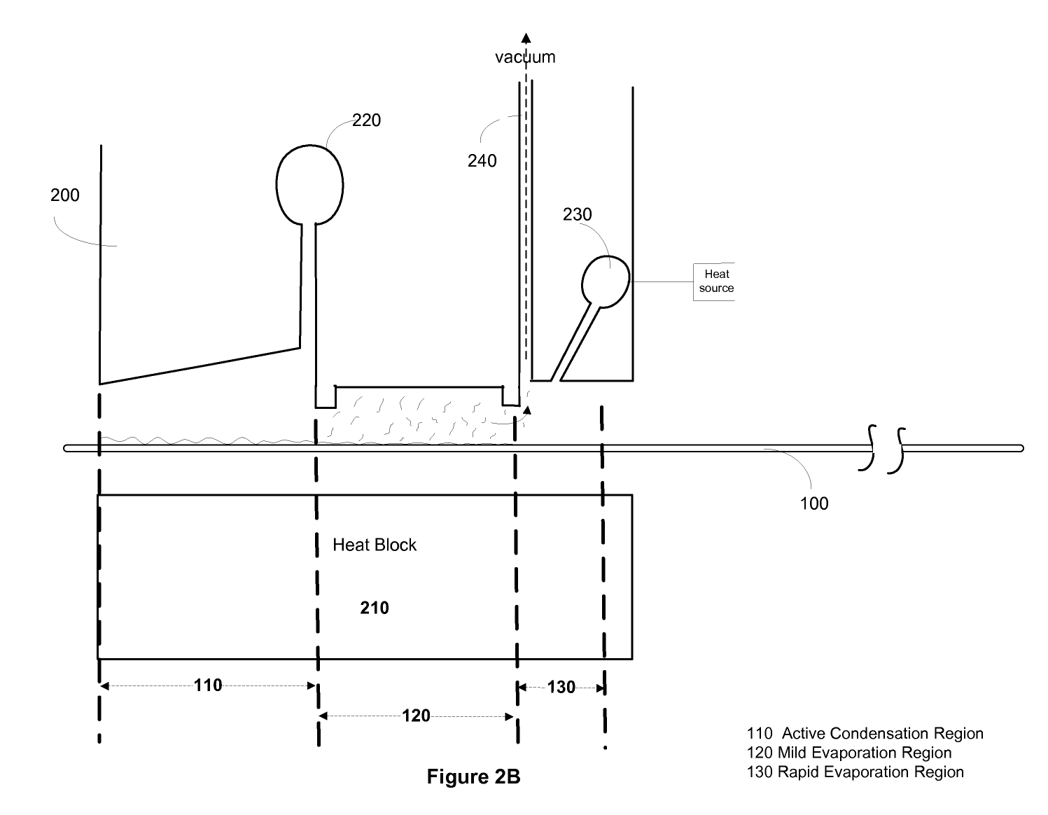

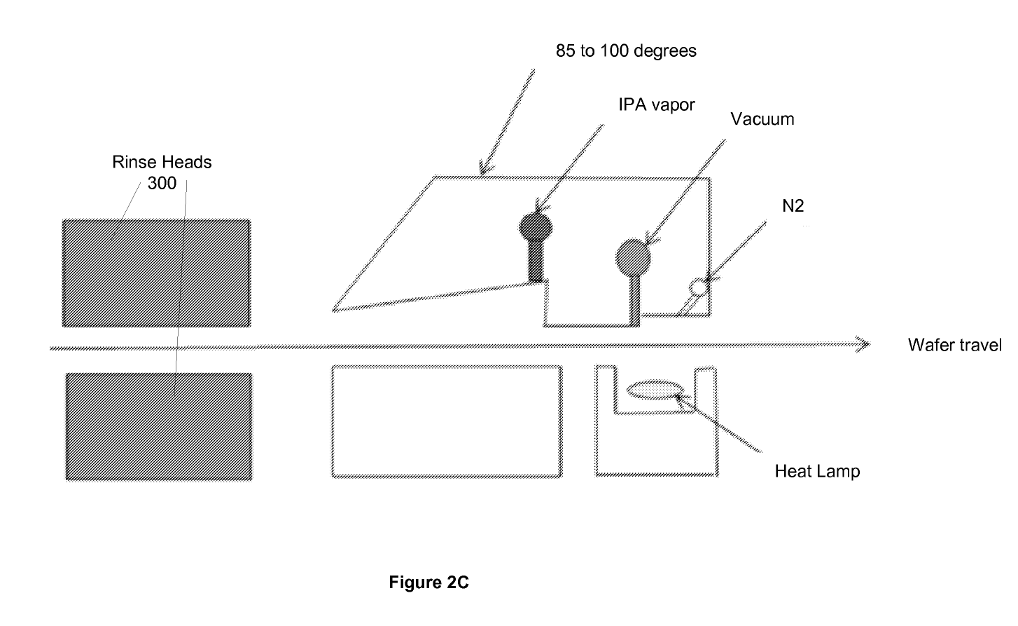

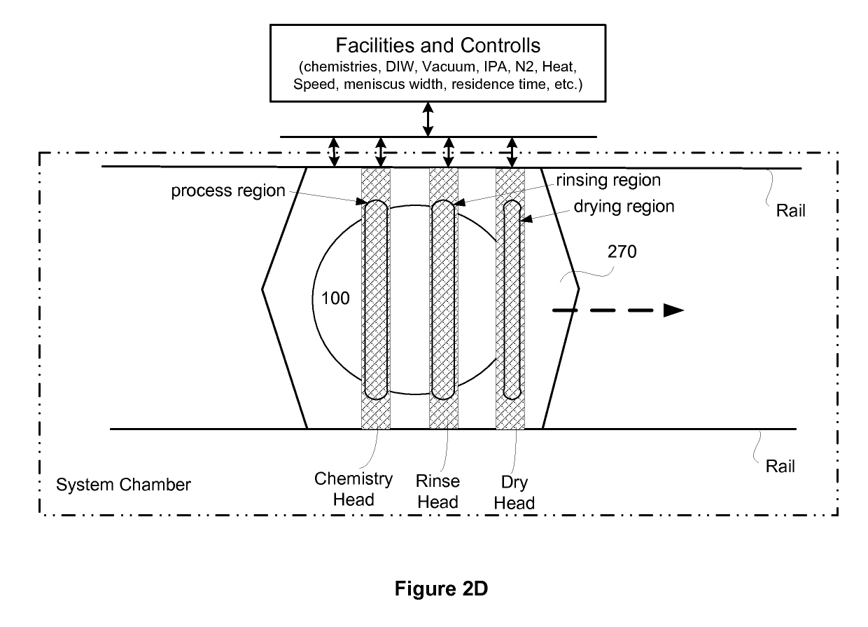

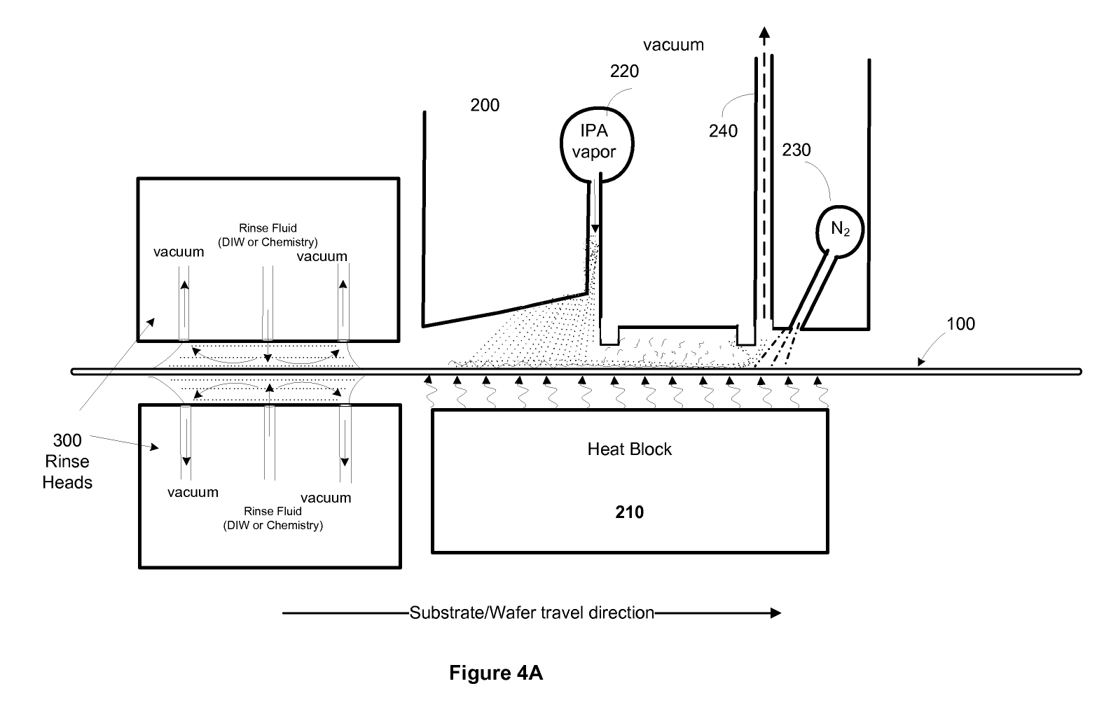

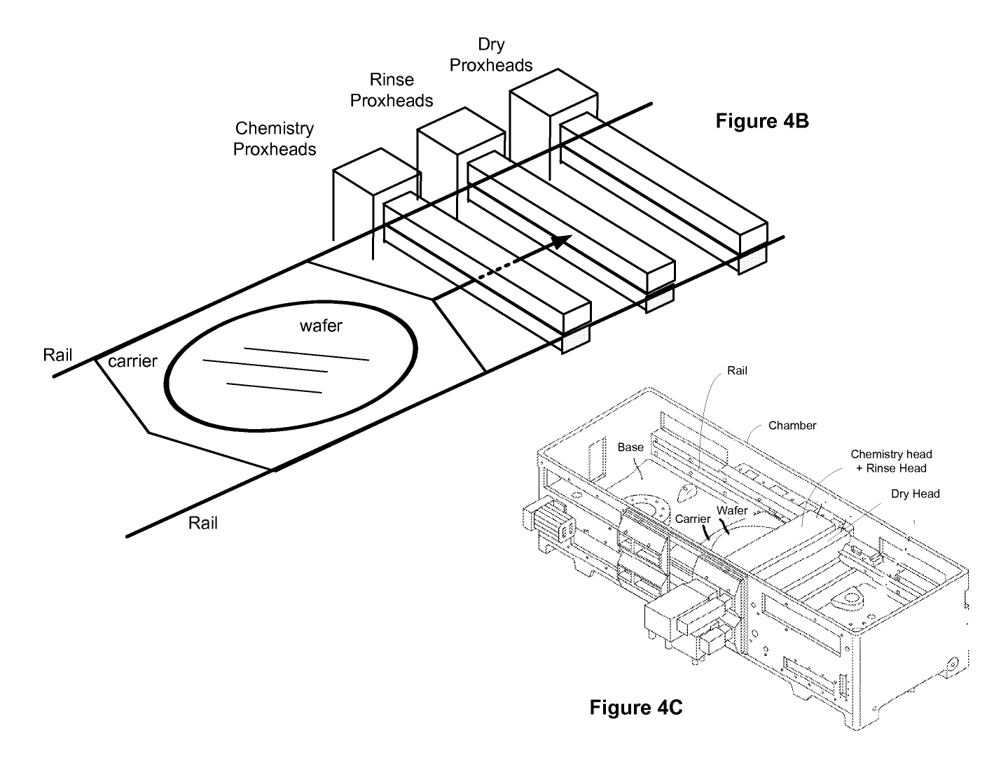

FIG. 2A illustrates a simple schematic representation of a separate dry head 200 with distinct regions used in the drying process, in one embodiment of the invention. The dry head 200 is separate from a rinse head that is used to rinse the wafer prior to the drying process. As noted above, however, it is possible to integrate the drying head with the rinsing head, but it is preferable to maintain a separation between the rinse meniscus and the drying region. FIGS. 4B and 4C illustrate these alternate embodiments.

The drying operation begins when the wafer 100 moves from under the rinse head (not shown) and into a processing region defined under the dry head 200. A thin layer of rinsing chemistry, such as deionized water (DIW), remains on the wafer from the rinsing operation (as shown) as the wafer moves under the dry head. In route to the dry head, IPA, which is at a concentration above the wafer's condensation point, condenses on top of the thin layer of DIW. In one embodiment, the rinse head is made from a plastic material, a metallic material, or a combination of plastic and metallic materials. No matter the material used, the material should be chemically inert.

The dry head 200 is a proximity head defined from a head body 290 with a process surface 270 having a plurality of inlets and outlet ports (i.e., conduits) for performing the drying operations. The inlet and outlet ports are arranged to define distinct treatment regions on the surface of the wafer during a drying operation. The regions preferably extend a length of the head, so that the wafer surface can be treated as the wafer is moved under the head, as shown in FIG. 2D. The distinct regions in the dry head 200 itself, are designed to displace the high surface tension rinsing fluid and replace such fluid with a low surface tension fluid (i.e., IPA) over the wafer surface, while quickly evaporating the IPA from the wafer surface in a final dry phase.

In one embodiment, the distinct regions defined in the dry head 200 include an active condensation region 110, a mild evaporation region 120 and a rapid evaporation region 130. Each of the distinct regions will now be described with reference to FIG. 2A. As the wafer moves out of the rinse head (300 shown in FIG. 2C) and under the dry head 200, the wafer is first exposed to a first region disposed at a leading edge 250 of the dry head 200. It should be noted herein that, in one embodiment, as the wafer moves from under the rinse head, the rinse chemistry or DIW used at the end of the rinse cycle condenses on the wafer surface preventing the wafer surface from drying before moving under the dry head. The first region defines an active condensation region. The active condensation region covers a region between the process surface 270 of the dry head 200 and the wafer surface 100 and extends a width of the first region. An IPA applicator 220 is defined near the leading end/edge 250 of the dry head 200 and includes a first set of inlet ports through which IPA is applied in vapor form to a cavity region 285, defined in the dry head 200 over the active condensation region. The IPA is heated to form vapor and the vaporous IPA is applied to the wafer surface as a vapor meniscus through the first set of inlet ports.

In one embodiment, the first set of inlet ports providing the IPA is disposed in the first region such that the distance between the center of two subsequent aligned inlet ports is about 0.12 mm. In one embodiment, the cavity region 285 is recessed into the head body 290 and is defined by a flat surface 275 at the leading edge of the process surface and a tapered surface 280 that is disposed adjacent to the flat surface 275. The tapered surface 280 tapers from the flat surface 275 into the head body toward the first set of inlet ports, as illustrated in FIG. 2A. In another embodiment, the cavity region 285 is defined by an angled surface, as shown in FIG. 4A. Irrespective of the configuration, the cavity region provides a recess within the dry head 200 into which the IPA vapor is supplied and at least partially contained.

In one embodiment, a vaporizer is engaged to heat the IPA. In this embodiment, the vaporizer is connected to the IPA applicator 220 of the dry head 200 with conduits and is configured to heat the IPA to a pre-defined temperature and supply the heated IPA vapor to the wafer surface through the first set of inlet ports of the IPA applicator 220. Thus, the process surface 270 of the dry head 200 is configured to define a cavity region 285 within the first region so as to enable injection and substantial containment of the IPA vapor within the active condensation region 100 when the wafer is present. In one embodiment, the vapor is 100% IPA. In another embodiment, the IPA vapor is about 95% IPA and about 5% deionized water. In one embodiment, the IPA mixture is an azeotropic mixture that is about 87.9% by weight IPA and about 12.1% by weight deionized water (DIW). Variations in percentages are possible and acceptable depending on the desired processing environment and process supplies available in the local clean room.

An azeotropic mixture, as is well known in the industry, is a mixture of two or more liquids in a ratio that its composition cannot be changed by simple distillation. As a result, when an azeotropic mixture is boiled, the resulting vapor has the same ratio of constituents as the original mixture. The IPA mixture is therefore “super-heated” and applied to the surface of the wafer as vapor. In one embodiment, the IPA mixture is heated to about 90-100 degrees centigrade (C) prior to being applied on the wafer surface. In another embodiment, the IPA mixture is heated to about 10 degrees to about 20 degrees C. above the boiling point of the IPA and applied to the wafer surface in vapor phase.

By applying the IPA in vapor phase, the drawbacks associated with the liquid phase IPA are avoided, while providing better control of quantity, uniformity, body force, etc. In one embodiment, heated IPA mixture condenses more evenly over a cool wafer surface to form a thin layer of IPA. In one embodiment, a heat block 210 (or similar heating structure) is provided at an underside of the wafer, as illustrated in FIG. 2A. Heat block 210 is used to transfer heat to the wafer, which in turn transfers heat to the applied IPA mixture on the top surface. As the wafer moves over the heat block, the wafer is progressively heated, and the IPA mixture tends to condense over the wafer surface before the heat block heats the wafer extensively thereby preventing such condensation.

The heat block 210 may be heated by any one of resistive heating, coil heating, infra-red lamps or by any other source that is known in the industry. In one embodiment, an aluminum cast heater is used as a heat source. In one embodiment, the heat block 210 is used to generate about 250 deg. C. to about 350 deg. C. heat. In another embodiment, the heat block is used to generate heat that is lower than an auto ignition temperature for IPA. Typically, the auto ignition temperature for IPA is about 385 deg. C. So, in order to avoid auto ignition, the heat block 210, in one embodiment, is used to generate heat that is below the auto ignition temperature for IPA.

The condensation of the IPA will enhance the Marangoni effect at the surface tension gradient interface, allowing the rinsing fluid to easily release from the wafer surface and flow away from the IPA mixture. As the rinsing fluid flows away, the IPA mixture flows in to fill the space vacated by the rinsing chemistry. Thus, the IPA applicator 220 enables focused application of the heated IPA, such that the rinsing chemistry is efficiently displaced from the active condensation region 110 of the wafer surface that is exposed to the heated IPA and replaced by the IPA without damaging the features.

In one embodiment, the IPA is applied through the IPA applicator 220 at a rate of about 5 to about 70 gms/min, with a medium range of about 10 gms to 30 gms/min, with one example rate of about 15 gms/min. In one embodiment, the IPA is heated between about 90-100 deg. C. before it is applied to the wafer surface. In one embodiment, additional heated IPA is injected to increase the concentration of the IPA in the active condensation region 110.

A plurality of outlet ports disposed in a second region of the dry head are connected to a vacuum source 240 and are configured to remove any IPA vapor escaping from the active condensation region 110 and occupying the mild evaporation region 120 under the dry head 200. The vacuum applied through the outlet ports at the mild evaporation region 120 is sufficient to substantially remove the IPA vapor, that did not go toward the rinse head, thereby preventing the IPA vapor from escaping from the active condensation region 110. In one embodiment, the vacuum applied enables between about 15 to about 30 liters/minute removal rate for a full sized head that covers a length of a 300 mm wafer.

A Nitrogen applicator 230 is defined at a third region near a trailing end/edge 260 of the dry head 200 to introduce Nitrogen to the wafer surface, such that the Nitrogen is applied to cover a rapid evaporation region 130 on the surface of the wafer. The plurality of outlet ports are located between the IPA applicator and the Nitrogen applicator of the dry head 200. In one embodiment, the plurality of outlet ports are located at an interface between the second region and the third region. In yet another embodiment, additional plurality of outlet ports may be optionally disposed over the second region.

In one embodiment, the Nitrogen applicator 230 of the proximity head encompassing a rapid evaporation region 130 on the surface of the wafer (substrate), when present, and includes a second set of a plurality of inlet ports that are angled between perpendicular and parallel in relation to the wafer surface so as to supply Nitrogen as a jet toward the rapid evaporation region. In one embodiment, the Nitrogen jet acts to push any remnant rinsing fluid or IPA mixture away from the rapid evaporation region 130 and toward the mild evaporation region 120 on the surface of the wafer and the plurality of outlet ports connected to a vacuum source (resulting in a dry wafer surface exiting the dry head 200).

In one embodiment, the Nitrogen is applied as a high-volume spray through the Nitrogen applicator at a rate covering a broad range of about 10 to about 100 liters/minute, with a medium range of between about 20 to about 40 liters/min, and with an example rate of about 30 liters per minute. In one embodiment, the Nitrogen is heated before it is applied to the wafer surface in spray form. In this embodiment, the Nitrogen is heated to about 100 deg. C. before it is applied to the wafer surface through the angled inlet ports. The dry head 200 extends the length of a wafer, so the plurality of angled inlet ports will also be disposed as discrete holes along the length of the dry head 200. In this embodiment, the heated Nitrogen causes a final evaporation of the IPA mixture. In one embodiment, the width of the active condensation region and the mild evaporation region on the wafer surface are about the same while the rapid evaporation region is reduced. Other configurations of the different treatment regions may be defined at the dry head 200 so long as the dry head 200 is able to provide enhanced cleaning/drying process without causing any feature collapse.

In one embodiment, the application of the IPA mixture and Nitrogen using the dry head 200 assists in displacing the rinsing chemistry in the following way. First the Marangoni effect keeps almost all of the rinsing chemistry from adhering to the surface of the wafer. Second the IPA vapor is applied in quantity sufficient to dilute the remaining rinsing chemistry to a very low percentage (for e.g. less than the azeotrope mixture). Third the Nitrogen and the heat energy cause drying in the feature while the feature is still in liquid contact with IPA meniscus. It is theorized that the full surface tension forces do not have time to act on the feature due to the feature still being in fluid contact with the IPA meniscus. Thus, the application of the heated IPA vapor, additional heat, and subsequent application of heated Nitrogen to the wafer surface results in fast drying of the IPA and diluted rinsing chemistry.

Part of the IPA mixture accelerates at the same rate as the kinetic velocity of the Nitrogen molecules moving through the IPA mixture. Some of this IPA mixture redeposit in the cooler region of the wafer under the dry head thus total IPA usage is less than what would be expected for the thickness of the coating. The rapid evaporation of the IPA mixture reduces the surface tension near and between features, thus preventing features from collapsing and efficiently drying the surface of the wafer. Heat from the heat block 210 (which is optional) further helps in accelerating the displacement and subsequent evaporation by maintaining the IPA in vapor form, and heating the Nitrogen thereby causing an increase in the kinetic velocity of the Nitrogen molecules.

As mentioned earlier, conventional application included high volumes of DIW to low volume of IPA in the mixture. Typical IPA/DIW mixture in the conventional application left on the wafer after drying was about 60% DIW to 40% of IPA. As a result, during the drying operation, when the mixture evaporated at the azeoptropic temperature of the mixture, more DIW was left behind on the wafer surface. Since the DIW is known to have a higher surface tension than the IPA, greater force acted on the liquid (DIW) near the features, pulling the features together and causing one or more of the features to collapse. In order to overcome the increase in surface tension and to mitigate the damage due to the high surface tension, the current embodiments create a higher concentration of the IPA in DIW (using the dry head) on the surface of the wafer in the active condensation region. As mentioned earlier, the concentration of the IPA to DIW, in one embodiment, is about 95% IPA to 5% DIW. During the drying operation, when this IPA mixture is evaporated at the azeotrophic temperature, the IPA and DIW evaporate at the same rate.

However, as the volume of the IPA is greater than the DIW, more IPA is left behind in the capillary region surrounding the patterns and on the surface of the wafer after the evaporation, thereby substantially reducing the surface tension of the chemistry in the capillary region on the wafer surface. The left-over IPA is quickly evaporated using heated Nitrogen applied through the Nitrogen applicator without damaging the features. The heat from the heat block aids in the faster evaporation of DIW from the IPA mixture and the IPA from the wafer surface leaving behind a substantially dry and clean wafer with preserved pattern features.

FIG. 2B illustrates an alternate embodiment of the dry head illustrated in FIG. 2A. In this embodiment, portions of the process surface 270 of the dry head 200 defining the second region, are extended to further define the second region. The second region enables containment of the IPA within the mild evaporation region so that the displacement of the rinsing chemistry can be thorough.

FIG. 2C illustrates a simple block diagram of the system used in rinsing and drying the wafer surface after fabrication operation. As can be seen, a pair of rinse heads 300 are disposed on the top and underside of the wafer so that the wafer can be rinsed on both sides. The dry proximity head disposed over the top surface and a heat block with a heat lamp disposed on the underside of the wafer is used to perform the drying operation after the rinsing operation. In alternate embodiments, only one rinse head 300 is used for the top surface. Also, the heating of the underside of the wafer (under the dry head), can be accomplished using more than one heat structure. Further, as noted above, heating the underside can be optional. Still further, the dry head shown in FIG. 2C has a head surface shape (i.e., facing the wafer—when present), that can vary in topology and contours. So long as the drying is effected between the surface of the dry head and the surface of the wafer, various surface geometries may be used on the surface of the wafer and examples illustrated herein are simply examples.

FIG. 2D illustrates a top view of the wafer as the wafer moves under the various heads during rinsing and drying operation. As can be seen, rails are disposed to enable the wafer to move along a plane of motion. A carrier 270 is configured to receive, hold and move the wafer along the path defined by the rails in the direction of the plane of motion. As the wafer travels across the plane of motion, the wafer is subjected first to a chemical rinse using a chemistry head, liquid rinse using a rinse head and drying using a dry head (e.g., dry head 200). In one embodiment, the chemical rinse and liquid rinse can be integrated under a single rinse head. Each of the chemistry head, rinse head and dry head form a meniscus over a portion (i.e., outlined regions) of the wafer that is exposed under the respective heads. In one embodiment, the length of the meniscus covers at least a length of the wafer and the width of the meniscus is less than the width of the wafer. In another embodiment, the rinse head may be wider than the wafer. In operation, the wafer exiting from under the dry head will be dry. Further shown is facilities and controls, that enable the controlled delivery of chemistries, DIW, vacuum, IPA, N2, heat, and provide speed controls, meniscus with settings, residence time, etc.

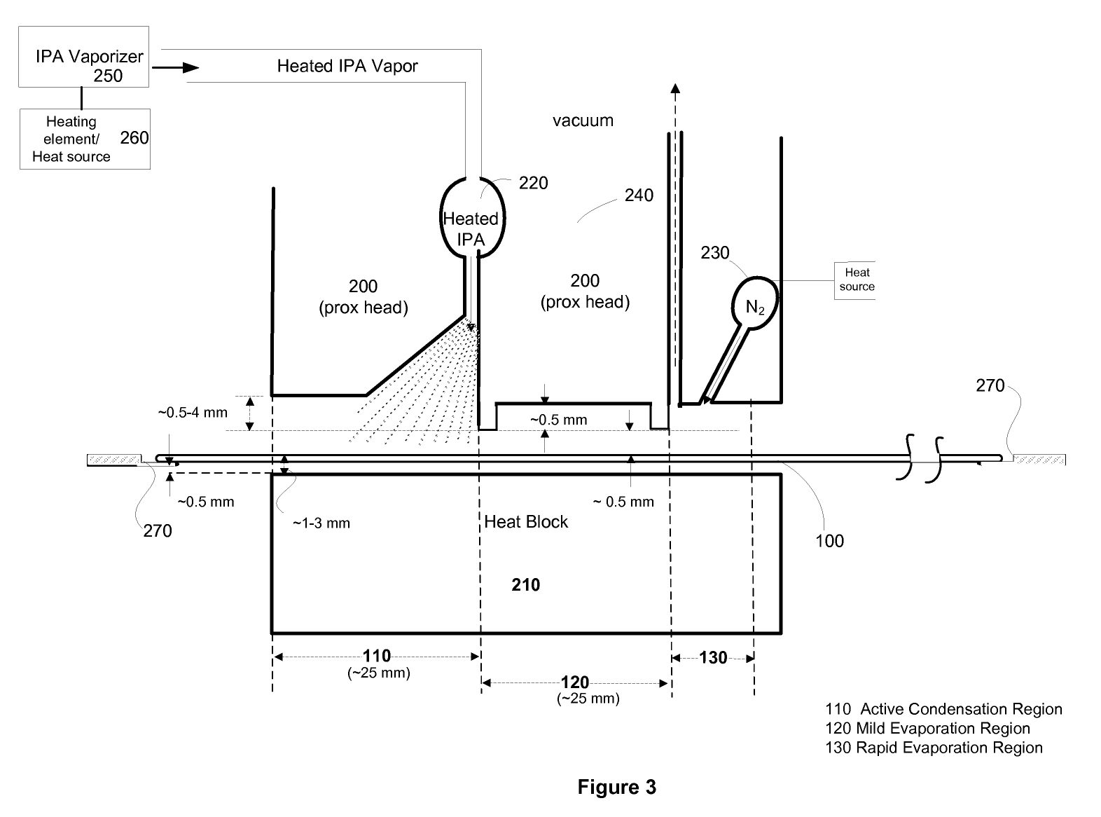

FIG. 3 illustrates a detailed representation of a dry head 200 used in the drying operation, in one embodiment of the invention. A vaporizer 250 is used to hold, heat and supply the heated IPA vapor to the wafer surface through an IPA applicator 220 using a first set of inlet ports in the dry head. The IPA applicator 220 defines an active condensation region 110 on the wafer surface. The vaporizer 250 may be connected to a heating element 260 which provides a heat source to heat the IPA contained within the vaporizer 250 to vapor form and supply the IPA vapor to the surface of the wafer. Applying IPA as vapor enables one to use small quantities of IPA to achieve optimal drying.

As illustrated, the example dry head 200 includes an IPA applicator 220 that defines an active condensation region 110 of about 25 mm in width on the wafer surface, a mild evaporation region of about 25 mm with on the wafer surface, and a rapid evaporation region of about 1 mm width on the wafer surface. Of course, these are just example dimensions, and these dimensions can be varied depending on the design of the flow rates, conduit/port hole orientations on the head surface and shape of the head. Continuing with example dimensions, and without limitation to commercial embodiments, the distance between a heat block and the top side of the wafer may be about 1-3 mm, and the distance between the heat block and the underside of the carrier may be between about 0.25 mm to about 3.0 mm with an example distance of about 0.5 mm. The distance between the opposing surface of the dry head 200 and the extensions in the dry head that form a third region is between about 0.5 mm to about 4 mm. The distance between the opposing surface of the dry head and the wafer surface in the rapid evaporation region 130 is about 1.5 mm. The plurality of outlet ports (for defining vacuum) defining mild evaporation region 120 is defined between the first set of inlet ports defining the active condensation region 110 and the second set of the inlet ports defining the rapid evaporation region 130, in one embodiment. The dry head 200 may cover the entire diameter of the wafer lengthwise and cover only a portion of the wafer widthwise.

In one embodiment, the process of drying a wafer surface using a dry head 200 includes applying a super-heated IPA vapor to a portion of the wafer surface defining an active condensation region 110. The term, “super-heated” as used in this application is defined to be a process where the IPA is heated to a temperature that is about 10 deg. C. to about 20 deg. C. greater than the boiling point of the IPA. The super heated IPA applied to the portion of the wafer surface displaces any liquid, such as rinsing chemistry or DIW, from the wafer surface and the hot IPA condenses on the cold wafer surface in areas where the liquid chemical was displaced. The heat block 210 further heats the IPA that has condensed on the active condensation region 110 of the surface of the wafer enabling the IPA to further displace any remnant rinsing chemistry.

More IPA may be injected onto the wafer surface at the active condensation region increasing the amount of IPA on the wafer surface. The heat from the heat block and the constant influx of the heated IPA keeps the active condensation region hot during the drying process. The IPA provides low surface tension at the wafer surface reducing the forces acting on the features, when present. Nitrogen is applied to the wafer surface at the rapid evaporation region to accelerate the evaporation of the IPA from the wafer surface. In one embodiment, the Nitrogen is also heated before being applied to the wafer surface. In one embodiment, Nitrogen is heated to about 100 deg. C. and applied to the surface of the wafer. A heating element similar to the one used to heat the IPA may be used to heat the Nitrogen before being applied to the wafer surface.

The heated Nitrogen hits the wafer surface, pushes the IPA back towards the active condensation region 110, rises over and rides on top of the IPA layer. Some of the IPA coming in contact with the Nitrogen mixes with the Nitrogen (N2) to form N2/IPA mixture. This N2/IPA mixture is pushed back towards the active condensation region and to the vacuum by the jet flow heated Nitrogen applied in the rapid evaporation region. The N2/IPA mixture moves from the cold active condensation region 110 to the hot mild evaporation region 120, where the N2/IPA mixture is quickly removed by vacuum applied through the outlet ports disposed in or near the mild evaporation region, and removed from the wafer surface. The heated Nitrogen aids in the fast mixing and evaporation of the IPA from the wafer surface. It should be noted herein that the parameters provided in FIG. 3 are exemplary and should not be considered limiting in any way.

FIGS. 4A and 4B illustrate a simple schematic representation of a system used in the rinsing and drying operation, in one embodiment of the invention. A wafer is received under a proximity head, such as a dry head 200, after a rinsing operation. In one embodiment, the rinsing operation is performed by another proximity head, such as a rinse head 300. The rinse head 300 provides rinsing chemistry or DIW to rinse the surface of the wafer 100 to remove contaminants and chemicals left behind by other fabrication operations. A conventional rinse head 300 may include an N2/IPA applicator at the trailing end of the rinse head to dry the wafer surface. The N2/IPA applicator was used to apply N2/IPA mixed with deionized water (DIW) to the wafer surface after the wafer had undergone rinsing to remove contaminants and residues left behind from other fabrication operations. The N2/IPA/DIW mixture used in the typical rinse cycle had low volumes of IPA in DIW. As a result, when this IPA mixture was subjected to evaporation, the IPA in the mixture evaporated faster leaving behind the DIW. As the wafer was dried, the high surface tension of the DIW caused a pulling force to act on the features ultimately collapsing the one or more features rendering the device inoperable.

To overcome the pulling force, the rinse head used in the current invention is modified to replace the N2/IPA applicator at the trailing end of the rinse head with a set of outlet ports configured to apply vacuum to the wafer surface as the wafer moves under the trailing end of the rinse head. The vacuum provides sufficient force to remove substantial amount of the rinsing chemistry and to pull IPA vapor and Nitrogen from under the dry head leaving behind at least a thin layer or some fluid of the rinsing liquid, such as DIW now mixed with IPA, on the wafer surface as the wafer moves from under the rinse head to under the dry head for drying.

Referring now to FIG. 4B, the system for rinsing and drying a wafer includes a wafer transporting device, such as a carrier 270, that is configured to receive, hold and transport the wafer 100 along a plane. A pair of rails is provided to guide the carrier as the carrier transports the wafer across the plane of motion. The system is not restricted to the carrier 270 but can use other means for receiving, holding and transporting the wafer along a plane. In one example, the system can includes a chemistry proximity head to apply one or more cleaning chemistries to the surface of the wafer as the wafer travels under the chemistry proximity head to rinse the wafer after a fabrication operation. The wafer coming out of the chemistry proximity head is subjected to a rinse under a rinse head where DIW is used to rinse away the chemistries used in the chemistry proximity head. The wafer then undergoes a drying operation under the dry proximity head. The dry head 200 has been described with reference to FIGS. 2 and 3. It should be noted herein that the chemistry proximity heads and rinse heads are disposed over the top and underside surfaces of the wafer to substantially rinse both the top surface and the underside surface of the wafer. Other embodiments only provide a head over the top surface. The dry head, on the other hand is disposed over the top surface of the wafer with an optional heat block disposed on the underside of the wafer so as to produce sufficient heat to heat the IPA condensing on the wafer surface during the drying operation.

FIG. 4C illustrates an exemplary ambient controlled chamber (without the lid to show the inside), in which the rinsing and drying system of the present invention may be disposed. The chamber includes a base and a set of walls enclosing the chamber. A set of rails are disposed on opposite walls of the chamber and act as guides directing the wafer along a plane of motion. A carrier disposed on the rails is configured to receive, hold and transport the wafer along a plane of motion guided by the rails. As the wafer moves along the plane within the chamber, the wafer is subjected to one or more rinsing operations under the chemistry heads and rinse heads and is dried under the dry head disposed within the chamber. In the exemplary system illustrated in FIG. 4C, a pair of chemistry heads and rinse heads are integrated to form a combined rinse head where the wafer is subjected to one or more rinses prior to being dried under the dry head. The wafer coming from under the dry head is substantially dry while keeping the features of the patterns formed on the wafer from collapsing.

The separate application of IPA and Nitrogen, the introduction of heated IPA vapor, the introduction of heated Nitrogen all help in substantially reducing the surface tension around the features while enabling efficient displacement of the high surface tension rinsing chemistries from the wafer surface during a drying operation. Using IPA in vapor form enables one to overcome the drawbacks that is commonly encountered with liquid IPA while providing increased displacement capability. Applying IPA in vapor form also reduces excess usage of IPA, while obtaining optimal result during the drying process.

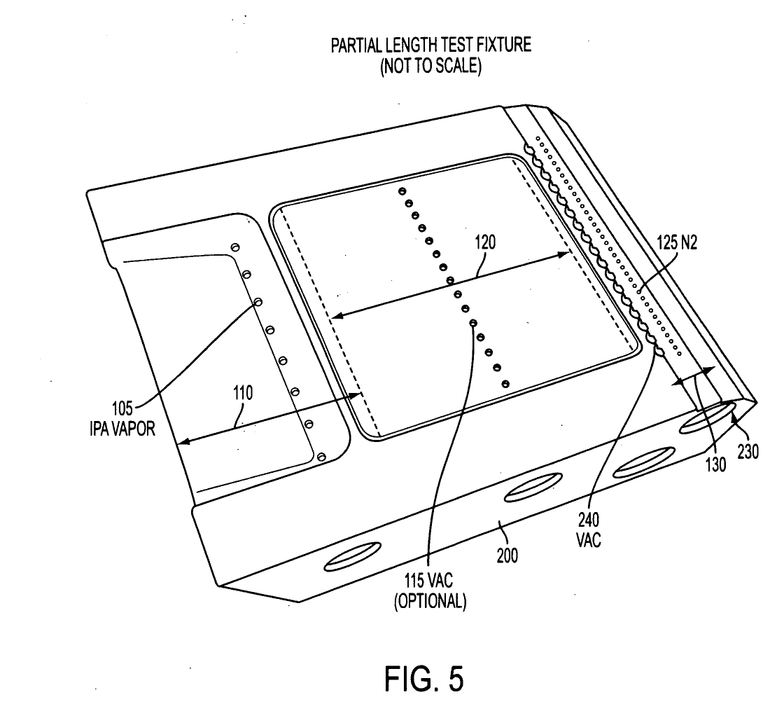

FIG. 5 illustrates a sample prototype test fixture, illustrating a short portion of the dry head 200 that may be used for drying the wafer, that defines the three distinct regions on the surface of the wafer. The active condensation region 110 is defined by a first set of inlet ports 105 at the dry head that is used to apply IPA in vapor form into a first region defined over the active condensation region. The rapid evaporation region 130 is defined by a plurality of second set of angled inlet ports 125 that is used to inject heated Nitrogen into a second region defined over the rapid evaporation region. A set of outlet ports 115 defining a mild evaporation region 120 is used to remove the rinsing chemistry released by the IPA vapor, the IPA vapor escaping from the rapid condensation region, IPA/Nitrogen mixture pushed back from the rapid evaporation region 130. Also shown are the vacuum ports that define vacuum 240, as shown in FIGS. 2-3. Notice that outlet ports 115 are not shown in FIGS. 2-4, but can be defined in region 120 to additionally remove evaporating fluids, before the final removal at vacuum ports 240. Again, the illustration of FIG. 5 is only a test fixture and is not made to scale for commercial use. The commercial embodiment will extend the width of a wafer, and will be sized based on the fluid flows and vacuum needed to achieve the desired drying operation.

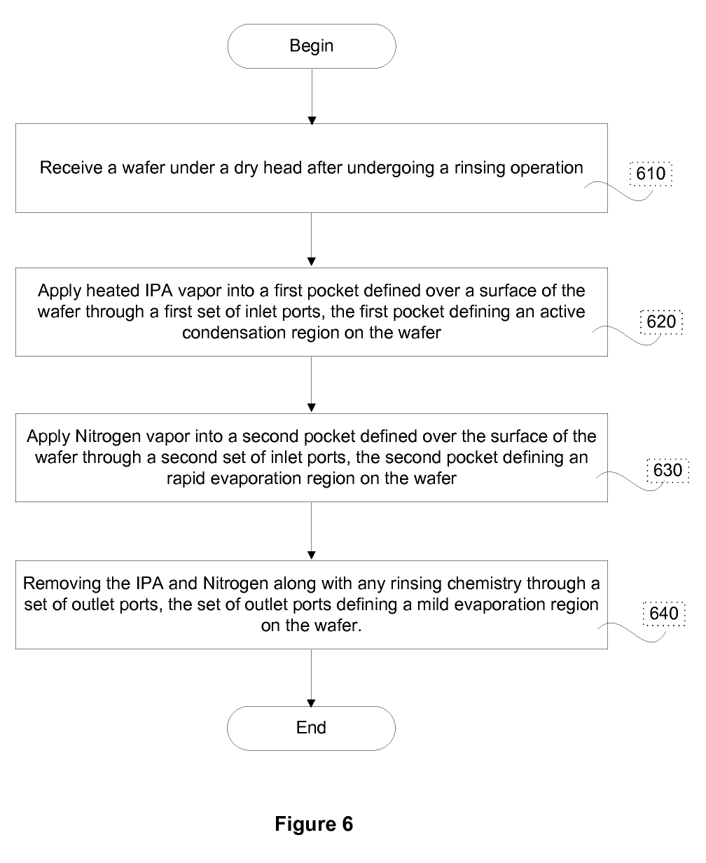

A method for drying a wafer surface will now be described in detail with reference to FIG. 6. The method begins with the wafer being received under the dry head after undergoing a rinsing operation under a rinse head, as illustrated in operation 610. Although the embodiments described herein disclose a rinse head for rinsing the wafer, the usage of rinse head is exemplary and should not be considered restrictive. Other tools that are well-known in the industry may be used in the rinsing operation, such as spin rinse and dry (SRD) units, etc. The wafer is received under the dry head with at least a thin layer of rinsing fluid, such as deionized water (DIW), on the surface of the wafer. The wafer undergoes drying operation under the dry head.

As the wafer moves under the dry head, heated IPA vapor is applied to the surface of the wafer at an active condensation region through a first set of inlet ports, as illustrated in operation 620. A first region is defined in the dry head where the first set of inlet ports are disposed so as to enable focused injection and substantial containment of the IPA vapor within the active condensation region. The IPA vapor actively displaces the rinsing chemical from the hard-to-reach capillary region formed in or around the features. The IPA vapor condenses on the surface of the wafer and in the capillary region where the rinsing chemical was displaced. In one embodiment, the thickness of the condensed IPA layer is about 100 micrometer. This layer of IPA, being thin, makes it easier to evaporate the IPA quickly. Heat from a heat source, such as a heat block, provided at the underside of the wafer enables conversion of the condensed IPA into vapor form. The rise in the temperature of the wafer due to the condensation of the IPA is about the same amount as the drop in temperature due to IPA evaporation.

As illustrated in operation 630, Nitrogen is heated and applied to the wafer surface through a second set of inlet ports. The second set of inlet ports are disposed in a second region in the dry head. The second region defines a rapid evaporation region on the wafer surface. The Nitrogen helps in the rapid evaporation of the IPA that remains on the wafer surface while keeping the surface tension in the capillary regions around the patterns low due to the low surface tension of the IPA vapor, and keeps the IPA meniscus in fluid contact with the features.

The process concludes with the IPA and Nitrogen along with any remnant rinsing chemical being quickly removed through a set of outlet ports (supplied with vacuum) defined in the dry head, as illustrated in operation 640. The set of outlet ports disposed between the first set of inlet ports covering the active condensation region and the second set of inlet ports covering the rapid evaporation region defines a mild evaporation region on the wafer surface. The outlet ports may be connected to a vacuum source to aid in the fast removal of the IPA, Nitrogen and rinsing chemical.

The above embodiments define an effective tool for drying a wafer surface using very small amounts of IPA liquid, applying it in vapor form and performing fast evaporation of low surface tension chemical. The benefits of this vapor application include being self limiting in the thickness of deposition on the wafer surface, being unaffected by surface tension that is commonly associated with liquid delivery, and being unaffected by body forces that are commonly encountered in liquid chemistry applications. The IPA vapor also causes sufficient surface tension gradient in the DIW at the point of contact causing the DIW to repel the surface thus making it easier to remove and segregate DIW from the IPA using the dry head. The thin layer of IPA vapor allows for the steep surface tension gradient further enabling segregation from the DIW much easier. The hot Nitrogen application, heat source to heat the condensed IPA and suction air flow in the mild evaporation region all aid in the fast removal of the IPA from the wafer surface leaving behind a sufficiently clean and dry wafer without damage to the features.

For information regarding the formation of a meniscus, in liquid form, reference may be made to: (1) U.S. Pat. No. 6,616,772, issued on Sep. 9, 2003 and entitled “METHODS FOR WAFER PROXIMITY CLEANING AND DRYING,”; (2) U.S. patent application Ser. No. 10/330,843, filed on Dec. 24, 2002 and entitled “MENISCUS, VACUUM, IPA VAPOR, DRYING MANIFOLD,” (3) U.S. Pat. No. 6,988,327, issued on Jan. 24, 2005 and entitled “METHODS AND SYSTEMS FOR PROCESSING A SUBSTRATE USING A DYNAMIC LIQUID MENISCUS,” (4) U.S. Pat. No. 6,988,326, issued on Jan. 24, 2005 and entitled “PHOBIC BARRIER MENISCUS SEPARATION AND CONTAINMENT,” and (5) U.S. Pat. No. 6,488,040, issued on Dec. 3, 2002 and entitled “CAPILLARY PROXIMITY HEADS FOR SINGLE WAFER CLEANING AND DRYING,” each is assigned to Lam Research Corporation, the assignee of the subject application, and each is incorporated herein by reference. For additional information about top and bottom menisci, reference can be made to the exemplary meniscus, as disclosed in U.S. patent application Ser. No. 10/330,843, filed on Dec. 24, 2002 and entitled “MENISCUS, VACUUM, IPA VAPOR, DRYING MANIFOLD.” This U.S. patent application, which is assigned to Lam Research Corporation, the assignee of the subject application, is incorporated herein by reference.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A proximity drying head for drying a surface of a substrate, comprising:
a head body including a process surface to be disposed opposite a surface of a substrate when present, the process surface including a first region, a second region and a third region, wherein,
the first region defined at a leading edge of the head body includes a cavity region, the cavity region is recessed into the head body and includes a plurality of inlet ports, the inlet ports defined for introducing a vapor fluid to the cavity region;
the second region disposed proximate to the surface of the substrate when present, and located beside the first region; and
the third region disposed proximate to the surface of the substrate when present, and located beside the second region, a plurality of vacuum ports defined at the interface of the second region and the third region, and the third region including a plurality of angled inlet ports that are directed toward the second region.

2. The proximity drying head of claim 1, further includes a vaporizer connected to the proximity drying head through one or more conduits.

3. The proximity drying head of claim 1, further includes a heating element connected to the vaporizer.

4. The proximity drying head of claim 1, further includes a heat block disposed opposite the process surface of the proximity drying head, and directed toward an underside of the substrate when present.

5. The proximity drying head of claim 1, wherein the proximity drying head is connected to a chamber, the chamber further including a rinse head disposed before the proximity drying head along a path, the path including rails for moving a carrier holding the substrate under the rinse head and the proximity drying head.

6. The proximity drying head of claim 1, further includes a system chamber including a chemistry head, a rinse head and the proximity drying head, the system chamber coupled to facilities and controls.

7. The proximity drying head of claim 1, wherein the cavity region has an angled surface that begins near the leading edge and tapers into the head body toward the plurality of inlet ports.

8. A method for performing a drying operation using a drying proximity head, comprising:
between a surface of the drying proximity head and a surface of a wafer, when the wafer is present,
(a) applying heated isopropyl alcohol (IPA) as vapor to the surface of the wafer, the wafer having undergone a rinsing operation by a separate rinse proximity head prior to the application of the isopropyl alcohol, the surface of the wafer having at least a layer of deionized water on the surface of the substrate from the rinsing operation, the isopropyl alcohol displacing the layer of deionized water thereby substantially lowering surface tension near any features formed on the surface of the wafer;
(b) heating a region under the wafer where the heated isopropyl alcohol is applied;
(c) injecting heated Nitrogen to the surface of the wafer, the heated Nitrogen aiding in substantially evaporating the deionized water and isopropyl alcohol from the surface of the wafer; and
(d) removing the deionized water and isopropyl alcohol from the surface of the wafer along with the Nitrogen so as to leave the wafer surface substantial dry;
(e) wherein (a)-(d) are performed between the surface of the drying proximity head and the wafer surface after the rinse operation performed by the separate rinse proximity head.

9. The method of claim 8, further includes heating the IPA to about 80-82 deg. C. using a heating element prior to applying the heated IPA to the surface of the wafer.

10. The method of claim 8, further includes heating the Nitrogen to about 100 deg. C. prior to injecting the Nitrogen to the surface of the wafer.

11. The method of claim 8, wherein the IPA is a mixture of about 95% IPA and about 5% deionized water.

12. An apparatus for drying a surface of a wafer, comprising:
a proximity head disposed over a top surface of the wafer when present, the proximity head having an opposing process surface disposed opposite a surface of the wafer when present with a plurality of inlet and outlet ports disposed therein, the inlet and outlet ports defining distinct treatment regions on the surface of the wafer, the proximity head including,
an IPA applicator disposed in a first region configured to apply heated isopropyl alcohol (IPA) as a vapor meniscus through a first set of inlet ports so as to cover an active condensation region over the surface of the wafer when present, the proximity head configured to define a cavity region so as to substantially contain the IPA vapor applied in the active condensation region;
a set of outlet ports disposed in a second region, the set of outlet ports connected to a vacuum source and configured to substantially remove the IPA and chemistry released from the surface of the wafer; and
a Nitrogen applicator disposed in a third region configured to apply Nitrogen through a second set of inlet ports so as to cover a rapid evaporation region over the surface of the wafer when present, the proximity head configured to substantially direct the Nitrogen toward the second region so as to substantially release and displace the isopropyl alcohol and any liquid chemical from around the features and on the surface of the wafer,
wherein the second region is adjacent to the first region and the third region is adjacent to the second region.

13. The apparatus of claim 12, further includes a vaporizer connected to the IPA applicator disposed in the first region of the proximity head, the vaporizer configured to supply the heated isopropyl alcohol in vapor form to the surface of the wafer through the proximity head, wherein the vaporizer is connected to a heating element to heat the IPA contained in the vaporizer.

14. The apparatus of claim 12, further includes a heat block disposed opposite the process surface and directed toward an underside of the wafer when present, the heat block configured to heat the IPA and the Nitrogen applied to the surface of the wafer.

15. The apparatus of claim 14, wherein the heat block is heated through one of a resistive heat source, infra-red lamp or a heat coil.

16. The apparatus of claim 12, wherein the set of outlet ports disposed at the mild evaporation region is located between the first set of inlet ports disposed in the first region and the second set of inlet ports disposed in the third region to substantially remove the mixture and the isopropyl alcohol from the surface of the wafer.

17. The apparatus of claim 12, wherein the second set of inlet ports are angled between perpendicular and parallel so as to apply the Nitrogen toward the mild evaporation region, the Nitrogen applied through angled second set of inlet ports aiding in substantially pushing the IPA and Nitrogen away from the rapid evaporation region and toward the mild evaporation region on the surface of the wafer so as to be substantially removed through the plurality of outlet ports disposed there-between.

18. The apparatus of claim 12, further includes a rinse head configured to apply rinse liquid to rinse the surface of the wafer so as to substantially remove chemicals left behind by earlier fabrication operations and to apply deionized water to the surface of the wafer prior to treating the surface of the wafer to the drying operation.

19. The apparatus of claim 12, further includes a reservoir disposed within the proximity head, the reservoir connected to the Nitrogen applicator and configured to store and supply Nitrogen to the surface of the wafer during the drying operation, the reservoir connected to a heat element to heat the Nitrogen.

20. The apparatus of claim 12, wherein the vapor meniscus applied in the active condensation region is in fluid contact with the rapid evaporation region such that there is a continuous film until dried.
